(19) United States
(12) Patent Application Publication
(10) Pub. No.: US 2013/0216323 A1
(43) Pub. Date: Aug. 22, 2013

(54) MACHINE TOOL

(71) Applicants: Matthias Reck, Ober-Ramstadt (DE); Frank Dolze, Darmstadt (DE); Karl Robert Hofmeister, Muehltal (DE); Patrick Gunsch, Heubach (DE); Erwin Sowa, Alsbach-Haehnlein (DE); Frank Wesp, Muehltal (DE)

(72) Inventors: Matthias Reck, Ober-Ramstadt (DE); Frank Dolze, Darmstadt (DE); Karl Robert Hofmeister, Muehltal (DE); Patrick Gunsch, Heubach (DE); Erwin Sowa, Alsbach-Haehnlein (DE); Frank Wesp, Muehltal (DE)

(73) Assignee: DATRON AG, Muehltal-Traisa (DE)

(21) Appl. No.: 13/819,075

(22) PCT Filed: Aug. 29, 2011
(86) PCT No.: PCT/DE11/01653

§ 371 Date: May 1, 2013

(30) Foreign Application Priority Data
Aug. 27, 2010 (DE) 10 2010 035 669.7

(51) Int. Cl. B23C 3/00

(52) U.S. Cl. CPC B23C 3/00
USPC 409/137

(57) ABSTRACT

An automatic machine tool, particularly for producing a dental prosthesis of exact three-dimensional shape, includes a machining unit (200), a workpiece feed unit (300), a tool feed unit (400) and an operating and control unit. The machining unit (200) includes a machining tool (430) that is displaceable in three spatial directions and has a cardanic workpiece holder receptacle (210) that can be pivoted about two axes, wherein the workpiece holder receptacle (210) is arranged vertically and the machining of the workpiece is carried out in vertical arrangement so as to allow the dropping of chips.

The invention relates to an automatic machine tool, particularly for producing dental prostheses of an exact three-dimensional shape, as per the type of the independent claim 1.

### PRIOR ART

An automatic machine tool for producing dental prostheses, particularly crowns, abutments and/or politics of an exact three-dimensional shape, is already known from EP 1 1.06 146 A1, In this machine tool, a bearing for the workpiece and/or for the machining unit is designed, which serves as a motion unit with three translational axes in x, y and z direction. In this machine, automatic workpiece change is not provided. The machining is carried out in horizontal arrangement of the workpiece, wherein the machining is carried out along the three spatial directions x, y, z together with a rotation around an axis. The machine took does not comprise any automatic workpiece feed and/or tool feed. The problem with this machine tool is that the machining is carried out in horizontal direction so that the removal of the chips or of the milling waste produced during the machining process has to be taken care of, to ensure that the milling process is not disturbed and. that the result does not possibly even become unusable.

Furthermore, a machining in three spatial directions and only one rotational direction only allows for a limited formation of three-dimensional surfaces.

### Advantages of the Invention

In contrast, the automatic machine tool as per the invention has the advantage that is comprises a machining unit with a machining tool that is displaceable in three spatial directions, and has a cardanic workpiece holder receptacle that can be pivoted around two axes, which allows for the formation of any three-dimensional surfaces, such as required for dental prostheses. Moreover, owing to the workpiece holder receptacle being arranged in vertical direction and the machining of the workpiece in vertical arrangement, smooth machining of the workpiece is ensured, with chips, milling waste and the like falling down, and, in particular, there is no need to worry about chips, milling waste or the like to disturb the high-precision machining result.

Other advantages and characteristics of the invention are the object of the dependent claims referencing claim 1.

The drive into the three spatial directions is thus carried out preferably via appropriate servo/stepper motors or actuators. The cardanic workpiece holder receptacle that can be pivoted around two axes, is formed in one direction by a torque motor that can generate high dynamics and conveys the rotation around the first axis, and by a lever mechanism with a motor-driven spindle, which conveys the rotation around a second axis arranged vertically to the first axis. The drive as per the invention allows a workpiece to pivot by 180°, in particular, so that it can be machined from the front side in a first work step and from the back side in a second work step.

An advantageous further development provides for arranging a suction device underneath the workpiece holder receptacle, which generates a suction air current that is directed away from the workpiece to be machined and serves for removing any chips and dusts or similar occurring during the machining process.

In this way, a particularly effective removal of chips, milling waste or similar and at the same time a cooling of the workpiece is achieved by the suction air current flowing in vertical direction.

According to one advantageous embodiment, the workpiece feed unit comprises a workpiece holder magazine and a workpiece holder gripping device which takes a workpiece holder out of the workpiece holder magazine and feeds it to the workpiece holder receptacle. In this way, a whole number of workpieces can be machined in immediate succession in an automated manlier.

Herein, advantageously, it is provided for the workpiece holder to be of a basically circular ring shape, to be able to receive the circular disc-shaped workpieces, also called “blanks”, made of, for instance, cobalt chrome, PMMA (polymethylmethacrylate), nanocomposite, zirconia, and other materials available in sintered form. Herein, the workpiece holder comprises a first ring element to receive the circular disc-shaped workpieces, and a second ring element that can be attached to the first ring element, which slightly extends outside or overlaps the circular disc-shaped workpiece in the border area, and which features mushroom-shaped gripping elements on its front side, with which the workpiece holder gripping device engages.

Herein, the two ring elements can be fastened to each other via, for instance, screw connections or also via, for instance, bayonet caps. In this way, very quick workpiece change can be performed. The mushroom-shaped gripping elements on the top side allow for very good and process capable handling by the workpiece holder gripping device.

It is of particular advantage that the workpiece holder receptacle is composed of a planar support and a three-point holder with three pins engaging each time with the corresponding openings on the workpiece holder, of which one is axially movable and can be acted upon with a preset force. This three-point holder allows for very good repeatable positioning of the workpiece holder, with at the same time big holding forces applied in the machining area.

The machine tool, advantageously, is also provided with a tool changer and a tool feed unit for insertion of the tool each time required for machining, particularly milling tools.

It is of particular advantage that the tool feed unit comprises a basically fan-shaped tool spring receptacle which can be pivoted, through rotation by preset angles, into the machining area for delivery of a tool to, for instance, the milling or machining spindle of the machining unit. The tool spring receptacle allows for spring-loaded reception of the tools, which is advantageous for the delivery of a tool to the machining unit, in particular, as in this way minor positional inaccuracies, for instance, can be evened out, and the tool can be pushed into the machining unit during tool change in a spring-loaded manner and with the force defined.

The fan-shaped tool spring receptacle, that is, the shape of the tool spring receptacle being of the type of a fan, as a semi-circular segment of a circle, for instance, allows in a highly advantageous fashion the storing of the tool spring receptacle above the machining area and above the machining unit. The delivery of a tool to the machining unit is performed through a simple rotation and thus pivoting of the fan-shaped tool receptacle into the machining area. In this way, tool changes can be performed very quickly, and no additional traversings for the machine tool are required to change tools.

The fan-shaped tool spring receptacle is preferably a circle segment-shaped steel sheet with radial cuts to form the spring receptacles. By means of these cuts, the spring-loaded formation of the segments is carried out in a way easy to perform.

The operating and control unit of the machine tool is formed by a mobile computer that can be attached to the machine tool, which communicates with the control electronics of the machine tool via an interface. This computer can be, for instance, a notebook computer, such as an iPad, but it can also be a mobile telephone with an appropriate touch-screen operating interface, an iPod or similar. A touch screen is highly advantageous for the operating interface, which allows for operating via a touch-sensitive screen. The interface can be a WLAN, network or USB interface.

It is of particular advantage to link the operating device to the machine control as a browser application. Herein, the machine control acts as a web server allowing for the communication between the machine and the iPad as an HTTP client. This is why it is possible to employ basically any data communication devices, such as iPads, iPods, iPhones, notebooks, etc.

### DRAWINGS

Examples of embodiments of the invention are represented in the drawings and explained in more detail in the following description.

Are disclosed in:

FIG. 1 an isometric view of part of an automatic machine tool as per the invention;

FIG. 2 a side view of the part represented in FIG. 1 of the automatic machine tool as per the invention;

FIG. 3 a side sectional view of a tool holder;

FIG. 4 a partially cut-out front view of a workpiece holder;

FIG. 5 an isometric cut-out representation of a machine tool as per the invention;

FIG. 6 a front view of the machine tool represented in FIG. 5;

FIG. 7 a front view of the machine tool represented in FIG. 5 during tool change;

FIG. 8 a front view of the machine tool represented in FIG. 5 during tool change;

FIG. 9 a side view of the machine tool to illustrate the workpiece change;

FIG. 10 an isometric out-out representation of the machine tool to illustrate workpiece change;

FIG. 11 a front view of the machine tool represented in FIG. 10 during workpiece change;

FIG. 12 a front view of the machine tool represented in FIG. 10 during workpiece change;

FIG. 13 part of the machining unit to illustrate the clamping system;

FIG. 14 a side view of a workpiece holder clamped in a zero-point clamping system;

FIG. 15 the arrangement, schematically, of an input and operating device at the casing of the automatic machine tool;

FIG. 16 an input and operating device, schematically, prior to its fastening to the casing of the automatic machine tool, and

FIGS. 17-20 various views of a magazine and the workpiece holder to be fastened in it.

### EMBODIMENTS OF THE INVENTION

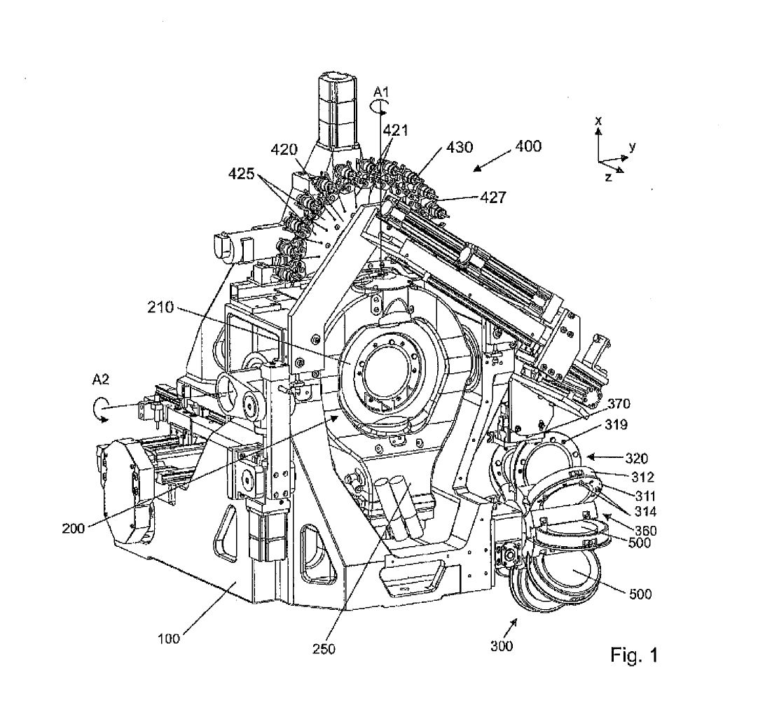

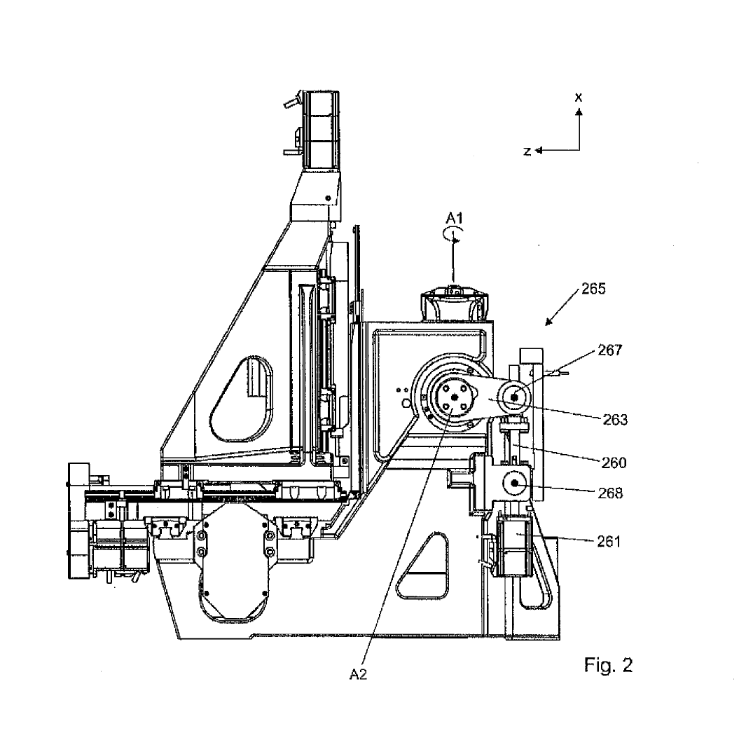

An automatic machine tool, represented in FIG. 1, particularly for producing dental prostheses of an exact three-dimensional shape, comprises a machining unit 200, a workpiece feed unit 300, and a tool feed unit 400. The machine is operated by an operating and control unit (not represented in FIG. 1 and FIG. 2).

The machining unit 200 comprises a milling spindle that is displaceable in three spatial directions x, y, z, with a machining tool 430. The displacement in the spatial directions x, y, z is carried out by servo/stepper motors or actuators (not represented).

Moreover, the machining unit 200 comprises a workpiece holder receptacle 210 which, gimbal-mounted, can be rotated around two axes: a first axis A1 extending basically in x direction, and a second axis A2 extending basically in y direction. The rotation around axis A1 is performed by means of a torque motor 250. This motor is capable of executing an adjustable and even big torque at high dynamics. The rotation into axis A2, aligned vertically to it, is performed by means of a lever mechanism composed of a spindle 260 which is motor-driven by a motor 261 and which produces a rotation around axis A2 through an appropriate assembly 265 consisting of a lever 263, a first bearing 267 and a second bearing 268 (FIG. 2). Herein, the rotation around both axes A1, A2 is performed with very high precision and dynamics. Owing to the machining directions x, y, z and rotating axes A1, A2, the machining of a workpiece, which in the case of dental prostheses is, for instance, a non-ferrous metal or a sintered material containing, amongst other things and by way of example, zirconia, is possible in every statial direction, so that any three-dimensional contours of high precision can be manufactured.

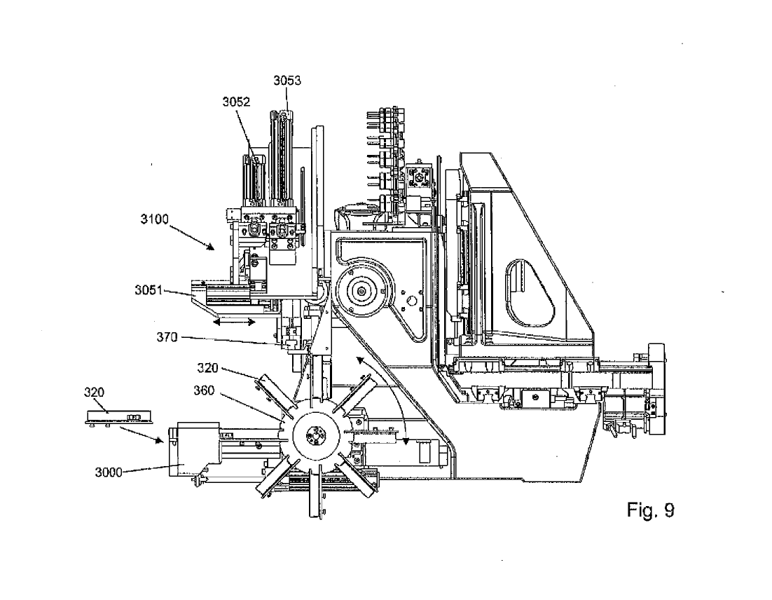

The workpiece feed unit 300 comprises a workpiece magazine 360 which can be, for example, a revolver magazine, as shown in FIG. 1 and FIG. 9.

Moreover, the workpiece feed unit 300 comprises a workpiece holder gripping device 370 which grips the workpiece holders 320 and feeds them to the machining unit 200 automatically, to be fastened, for instance, at the workpiece holder receptacle 210.

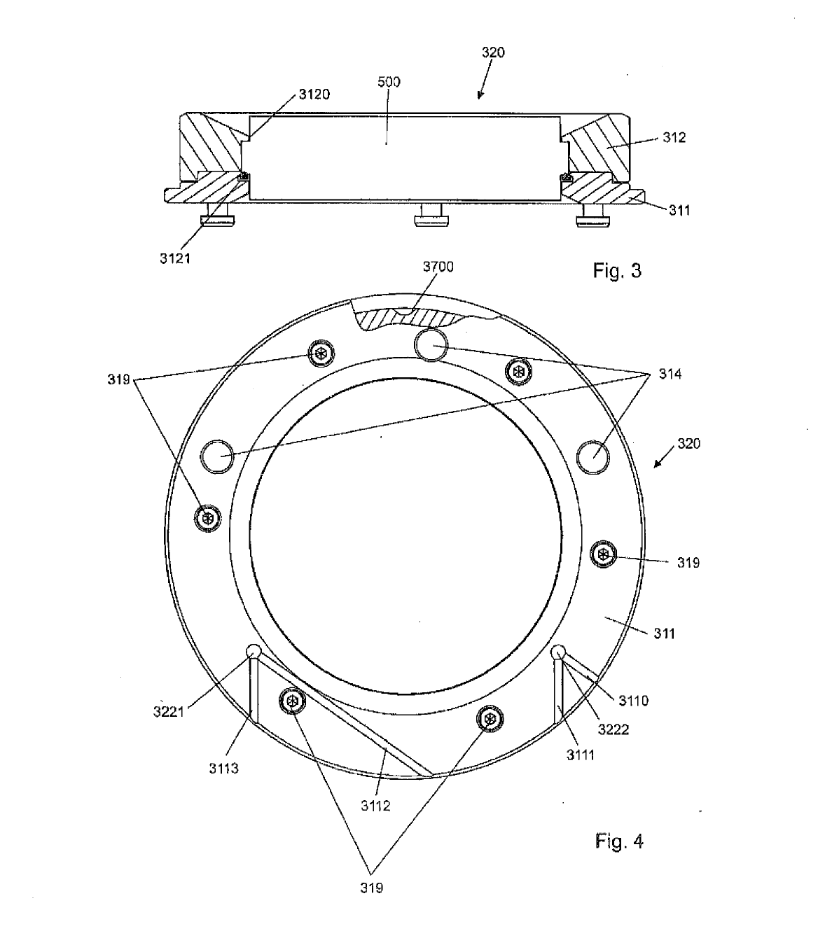

As demonstrated in FIG. 3 and FIG. 4, each workpiece holder 320 basically comprises two ring-shaped elements 311, 312 which are connected to each other by, for instance, screw connections, with inclusion of the workpiece 500. One of the rings, 312, serves to receive the workpiece 500, and it comprises to this end a salient 3120 which overlaps the workpiece. The other ring, 311, which is fastened to ring 312, slightly extends outside the border area of the workpiece 500 and holds it in ring 312 by means of an 0-ring 3121. 0-ring 3121 allows for resilient clamping and additionally has a damping effect during milling. Ring 311 comprises mushroom-shaped gripping elements 314 on its front side, with which the workpiece holder gripping device 370 engages and, in this way, takes the workpiece holder 320 out of the magazine 360 and feeds it to the machining unit 200, as schematically indicated in FIG. 1. This workpiece change is performed automatically. After machining, the workpiece holder 320, in the opposite way, is again taken out of the machining unit 200 and fed to the magazine 360.

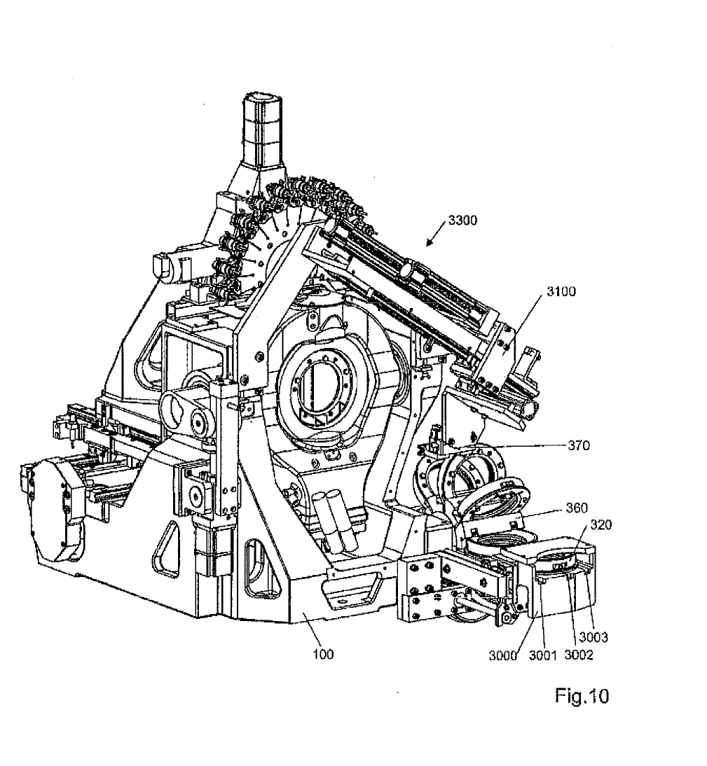

To handle the workpiece holder 320, guide grooves 3110, 3111, 3112, 3113 and snap-in points 3221 and 3222 are arranged in the front side of ring 311. Grooves 3111 and 3113 serve as lead-in grooves of a workpiece holder 320 arranged in a drawer-like receptacle 3000 (FIG. 9, FIG. 10), into the magazine 360, whereas grooves 3110 and 3112 serve as lift-out grooves from the drawer-like receptacle 3000 towards the machining unit 200. The drawer-like receptacle 3000 comprises an opening at its front side, in which grooves 3001, 3002 and 3003 are provided for. These grooves 3001, 3002 and 3002 are arranged in a way so that they can receive the mushroom-shaped gripping elements 340, Due to the arrangement of grooves 3001, 3002 and 3003, a placing of the workpiece holder 320 in the correct position in the drawer-like receptacle 3000 is secured.

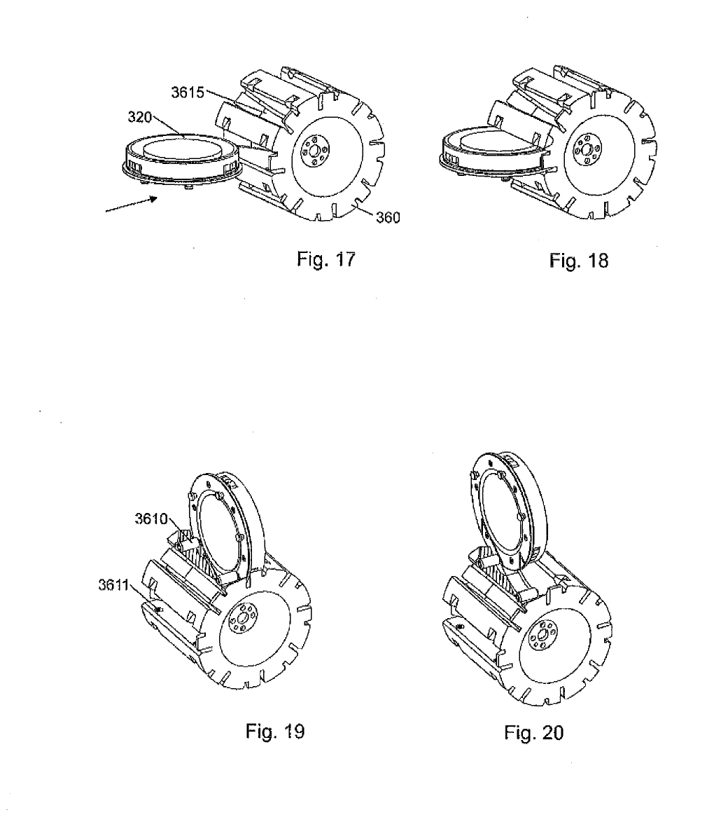

In FIGS. 17 to 20, the workpiece magazine 360 is represented, each time shortly before and after a workpiece holder 320 has been led in. As can be seen in FIG. 17, a recess 3615 matching the form of the workpiece holder 320 is provided in the magazine 360, In each recess, spring-loaded pressure pieces 3610 are provided (compare with the partially cut-out representation in FIG. 19), with for example, two of them per delivery position. These spring-loaded pressure pieces 3610 comprise balls 3611 on the side that is facing the workpiece holder 320, which engage with lead-in grooves 3110, 3111, 3112, 3113 and are locked in the snap-in points 3221 and 3222.

In this sense, the lead-in and lift-out grooves exercise some kind of track function in conjunction with the spring-loaded pressure pieces 3610, which are to support the process capability of the change process. The snap-in points 3221 and 3222 between the lead-in and lift-out grooves serve for secure arrest in the magazine 360.

Tool change is also performed automatically. To this end, a tool feed unit 400 is provided, together with a tool spring receptable 420. The tool spring receptacle 420 is composed of a fan-shaped, that is, a .circle segment-shaped steel sheet which comprises radial cuts 421 and in this way forms the spring receptacles 425, at the end of which tool holder receptacles 427 are arranged each time, in which the machining tools 430 are arranged.

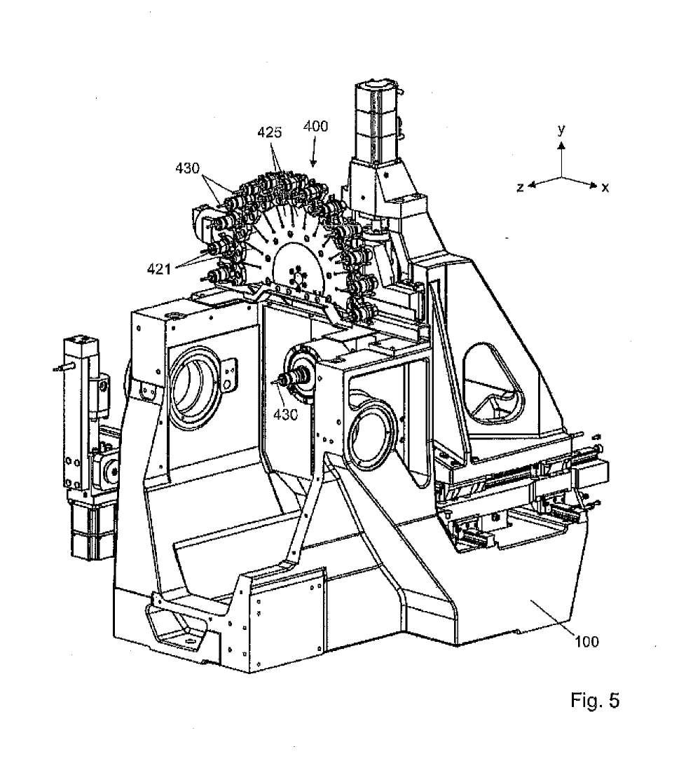

By a rotary motion of the tool spring receptacle 420, the machining tools 430 are pivoted into the machining area (which in FIG. 1 is arranged behind the workpiece holder receptacle 210, concealed by the latter and insofar not visible), and fed to the machining unit. For this reason, only part of the assembly is not represented in FIG. 5. The advantage of the fan-shaped tool spring receptacle 420 is that the tool spring receptacle 420 is arranged above the actual machining area and can be pivoted into the machining area by a simple rotary, that is, a pivoting motion. This allows for very quick and precise tool change without the machine tool having to perform any further traversing. The spring-loaded design of the spring receptacle 425 facilitates the delivery of the machining tool 430.

Tool change is explained below in more detail with reference to FIGS. 5 to 8.

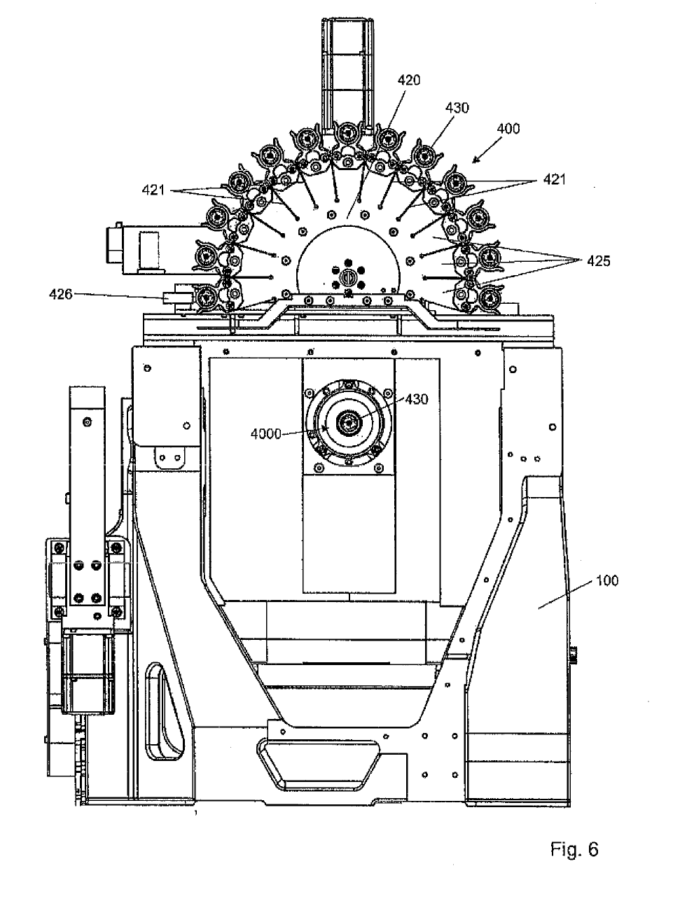

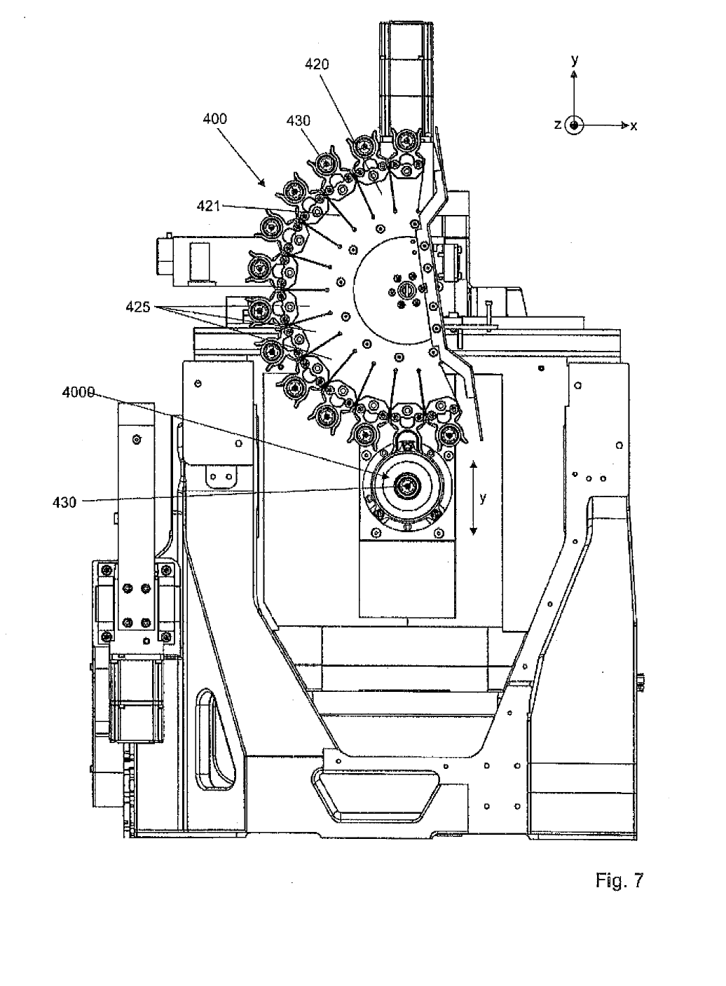

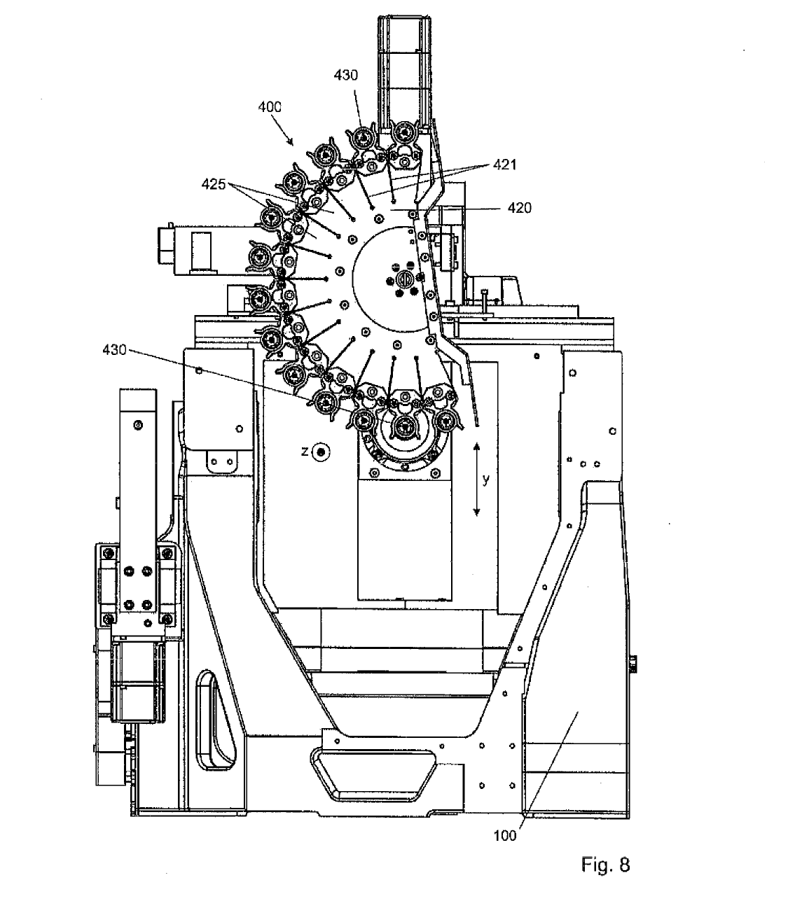

First, the tool spring receptacle 420 is in idle position (FIG. 5, FIG. 6). Then, the tool spindle leaves the collision area in y and and in z direction and, in x direction, goes right to the centre underneath the tool feed unit 400 which is also called tool changer. The tool spring receptacle 420 is rotated so that one free tool station comes to a halt exactly above the machining spindle 4000 (cf. FIG. 7). Subsequently, the tool spindle 4000 first goes to the level of the tool holder receptacle 420 in z direction (vertically to the sheet level in FIG. 6 to FIG. 8), and then inside the tool holder receptacle 420 in y direction. The machining tool 430 is actuated by the spindle 4000 which runs in z direction, that is, vertically to the sheet level in FIG. 6 to FIG. 8, and releases the tool 430 that far. These steps are represented in FIG. 7 and FIG. 8.

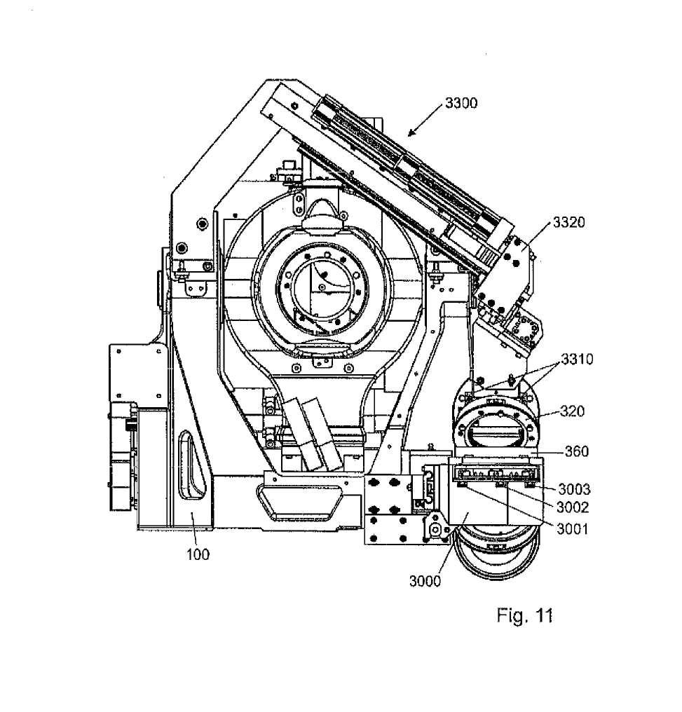

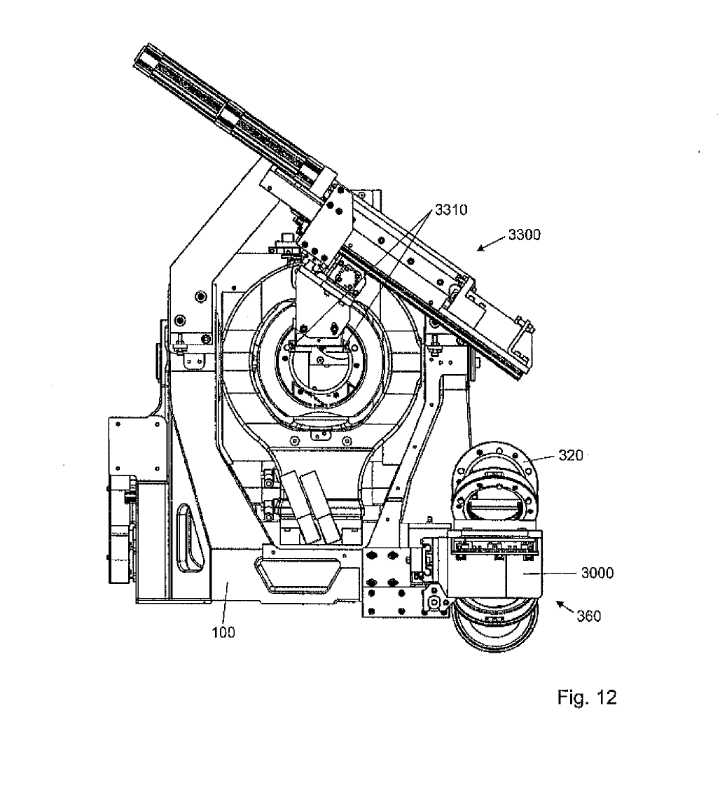

Workpiece change is explained below in more detail with reference to FIGS. 9 to 12. First, a workpiece holder 320 is fed to the drawer-like receptacle 3000 manually. Herein, the receptacle comprises grooves 3001, 3002 and 3003, arranged asymmetrically and adjusted to the mushroom-shaped gripping elements 314, which secure the leading in of the workpiece holder 320 in the correct position. After locking the receptacle 3000 and retracting the drawer into the workpiece magazine 360, the workpiece holder 3220 has become part of the revolver-like workpiece magazine 360. The workpiece magazine 360 can comprise, for instance, eight workpiece holders 320. Above the workpiece magazine 360, a displacing unit (workpiece holder receptacle device) 3300 is arranged which runs transversely from the workpiece magazine 360 up to the machining centre (FIG. 10, FIG. 11). The motion of the workpiece holders 320 is performed by means of compressed air. To this end, compressed air cylinders 3051, 3052 and 3053 are arranged in various directions (cf. FIG. 9). In FIG. 11, the process of picking up the workpiece holder 320 is represented. To this end, forceps-like grippers 3310 grip the mushroom-like salients 314 and lift the holders 320 out of the magazine 360 by actuation of the cylinder 3052. Thereafter, a gripper traversing unit 3320 runs upwards tranversely upon actuation of cylinder 3053, and then again backwards in the direction of the machining area upon actuation of cylinder 3051 (cf. FIG. 12) and delivers the workpiece holder 320 to the machining unit 200. To this end, grooves 3110, 3111, 3112, 3113 described above and the snap-in points 3221, 3222 are used for handling each time.

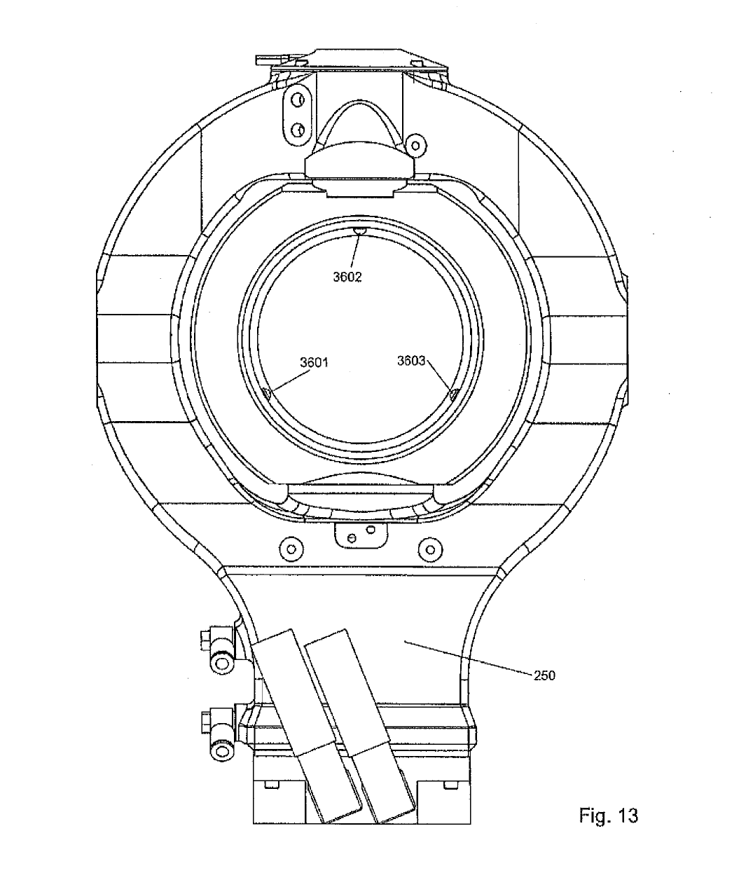

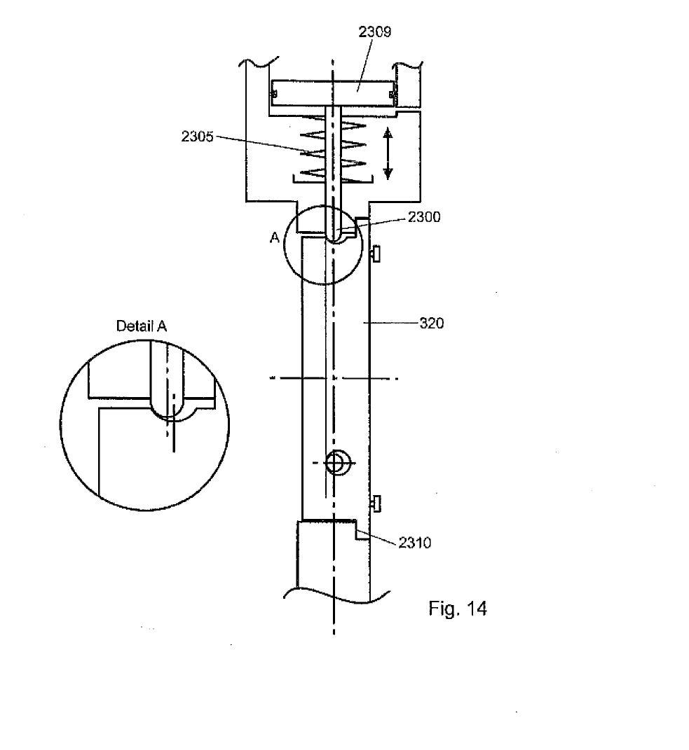

In the machining unit 200, the workpiece holder 320 is clamped in three points, as represented schematically in FIGS. 13 and 14. Such zero-point clamping system comprises three points 3601, 3602 and 3603 which are arranged in a way that they are basically displaced towards each other by 120°, that is, in a star-shaped manner. As represented in FIG. 4, so-called clamping slopes 3700 are formed in the area of these points with which the pins engage, wherein two fixed positioning pins are provided, for instance, in areas 3601 and 3603, and a spring-preloaded positioning pin 2300, in area 3602. This pin 2300 is actuated by a compressed air cylinder 2309, and it is movable. The holding position of the movable positioning pin 2300 is supported by a spiral spring 2305 with a high spring constant. Due to the slope, the workpiece holder 320 is pushed against a planar support 2310 by the spring force in case of a slightly off-centre position, and is thus positioned very precisely.

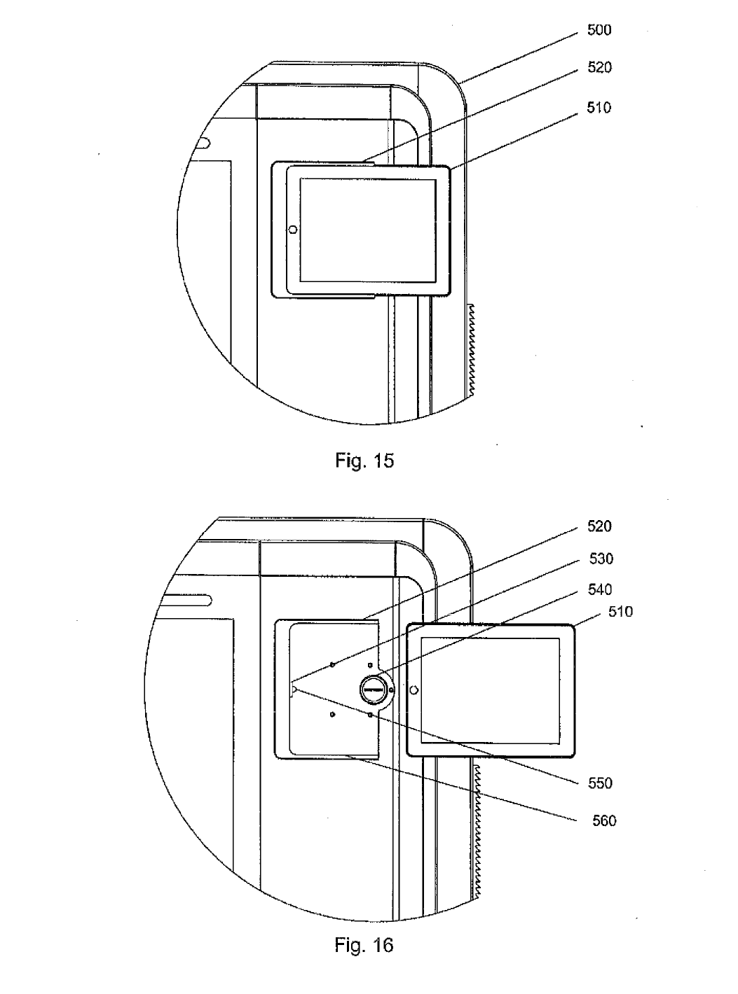

FIGS. 15 and 16 demonstrate schematically the arrangement of an input and operating device 510 at a casing 500 in the form, for example, of a cabin receiving the machine tool. A holder 520 is provided at the easing 500 into which the input and operating device 510 can be inserted from the side via the lead-in groove 560, in FIG. 16 from the right to the left. The operating device 510 can be, for example, a mobile computer or a so-called iPad, in particular. Apart from that, it is conceivable also to employ mobile telephones with a large display formed as a touch screen.

The holder 520 comprises, for instance, a USB interface 530 and/or a wireless interface 540, for instance, a WLAN antenna or similar. Furthermore, it is provided with an inductive proximity switch 550. As soon as the mobile input and operating device 515, for instance, the iPad in the receptacle 520 which is track-shaped and thus allows for secure fastening of the input device 510, has been fully inserted, an electrical connection is established with the USB or network interface 520, as well as a connection with the WLAN antenna 540. The inductive proximity switch 550 recognises that the iPad 510 is arranged in locked position, and releases in this respect the corresponding signal lines for the control of the machine tool. As long as the operating device in not inserted, it merely serves to display the status for security reasons but not for operations.

1. Automatic machine tool, particularly for producing dental prostheses of an exact three-dimensional shape, comprising a machining unit (200), a workpiece feed unit (300), a tool feed unit (400) and an operating and control unit, wherein the machining unit (200) comprises a machining tool (430) that is displaceable in three spatial directions and has a cardanic workpiece holder receptacle (210) that can be pivoted around two axes, wherein the workpiece holder receptacle (210) is arranged vertically and the machining of the workpiece is carried out in vertical arrangement so as to allow the dropping of chips.

2. Machine tool as per claim 1, wherein the cardanic workpiece holder receptacle (210) is formed by a torque motor (250) to be pivoted around a first axis (A1), and by a lever mechanism comprising a motor-driven spindle (260) to be rotated around a second axis (A2) arranged vertically to the first axis.

3. Machine tool as per claim 1, wherein a workpiece holder (320) and a workpiece (500) are arranged exactly in the rotation center of the cardanic workpiece holder receptacle (210).

4. Machine tool as per claim 1, wherein a suction device is arranged underneath the workpiece holder receptacle (210), which generates an air current flowing along the workpiece to be machined, that serves to remove any chips or similar occurring during the machining process.

5. Machine tool as per claim 1, wherein the workpiece feed unit comprises a workpiece holder magazine (360), and a workpiece holder gripping device (370) which lifts the workpiece holder (320) out of the workpiece holder magazine (360) and feeds it to the workpiece holder receptacle (210).

6. Machine tool as per claim 5, comprising basically circular ring-shaped workpiece holders (320) comprising a ring element (311) to receive circular disc-shaped workpieces (500), and a further ring element (313) that can be attached to this first ring element (311), which slightly extends outside the circular disc-shaped workpiece (500) in the border area and which comprises mushroom-shaped gripping elements on its front side, with which the workpiece holder gripping device (370) engages.

7. Machine tool as per claim 6, wherein an 0-ring (3121) is arranged between one ring element (311) and the workpiece (500) and/or between the other ring element (312) and the workpiece (500) to achieve resilient clamping and damping.

8. Machine tool as per claim 1, wherein the tool feed unit (400) comprises a basically fan-shaped tool spring receptacle (420) which can be pivoted into a machining area through rotation by preset angles, for delivery of the machining tool (430) to the machining unit (200).

9. Machine tool as per claim 8, wherein the fan-shaped workpiece spring receptacle (420) is a circle segment-shaped steel sheet with radial cuts (421) to form the spring receptacles (425).

10. Machine tool as per claim 1, wherein the operating and control is formed by an operating device (510) that can be fastened to the machine tool or its casing (500), which communicates with the control electronics of the machine tool via an interface (530, 540).

11. Machine tool as per claim 10, wherein the operating device (510) is a mobile computer and that wherein the operation is performed as a browser application, wherein the machine control works as a web server allowing for the communication between the machine tool and the mobile computer as an HTPP client.

12. Machine tool as per claim 10, wherein the interface is a WLAN, network or USB interface (530, 540).

13. Machine tool as per claim 10, wherein a holder (520) for the mobile computer (520) is provided at the machine tool, in which a wire-bound interface and/or a wireless interface has been integrated.

14. Machine tool as per claim 13, wherein an inductive proximity switch (550) is arranged in the holder (520), which detects the presence of the mobile computer (510).

15. Machine tool as per one of the claim 1, wherein the workpiece holder receptacle (210) is formed by a three-point holder with three pins engaging each time with the corresponding openings (3700) on the workpiece holder (320), of which one is axially movable and can be acted upon with a preset force.
